(19) United States
(12) Patent Application Publication
(10) Pub. No.: US 2010/0013754 A1
(43) Pub. Date: Jan. 21, 2010

(54) Liquid crystal display device

(75) Inventors: Huan-Xi Peng, Shenzhen (CN); Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZEN) CO., LTD.; INNOLUX DISPLAY CORP.

(21) Appl. No.: 12/460,475

(22) Filed: Jul. 20, 2009

(30) Foreign Application Priority Data
Jul. 18, 2008 (CN) 200810141627.3

(51) Int. Cl. G09G 3/36

(52) U.S. Cl. 345/98

(57) ABSTRACT

A liquid crystal display (LCD) device includes data lines, pixel units, a first repair line intersecting and disposed on a first side of the data line, a second repair line intersecting and disposed on a second side of the data line, a delay circuit connected between the first repair line and the second repair line, and a control circuit. The control circuit controls a delay time of the delay circuit according to a position of each pixel unit corresponding to a broken data line.

### BACKGROUND

1. Technical Field

The present disclosure relates to a liquid crystal display (LCD) device.

2. Description of Related Art

Generally, an LCD device includes a plurality of scanning lines, a plurality of data lines and a plurality of thin-film transistors (TFTs). Source electrodes and gate electrodes of the TFTs are connected to the data lines and the gate lines, respectively. When one of the data line is broken, no signal is fed to the broken line, resulting in deterioration in the quality of displayed images. The broken line should be repaired. Another LCD device including a repair line for restoring the broken line is provided accordingly. Two terminals of the broken line are connected through the repair line. An upper part of the broken line still can receive a data signal. A lower part of the broken line receives the data signal through the repair line.

Normally, data lines are very thin, exhibiting essential resistance accordingly. The data signal transmitted through the data line experiences a delay. On the contrary, the repair line is comparatively wide, so essential resistance thereof is almost zero, and data signals transmitted through the repair line experience almost no delay. However, when a break point occurs on a latter half of the data line, delay time of the data signal of the lower part of the broken line is less than that corresponding to positions of the other data lines. Therefore, brightness of pixels below the break point is different from that of other pixels in the same row. Display performance of the LCD device is thus likely to be affected.

What is needed, therefore, is an LCD device which can overcome the described limitations.

### BRIEF DESCRIPTION OF THE DRAWINGS

FIG. 1 is a circuit diagram of an embodiment of an LCD device according to the disclosure, the LCD device including a control circuit.

FIG. 2 is a circuit block diagram of the control circuit of the LCD device of FIG. 1.

### DETAILED DESCRIPTION

Reference will now be made to the drawings to describe preferred and exemplary embodiments of the invention in detail.

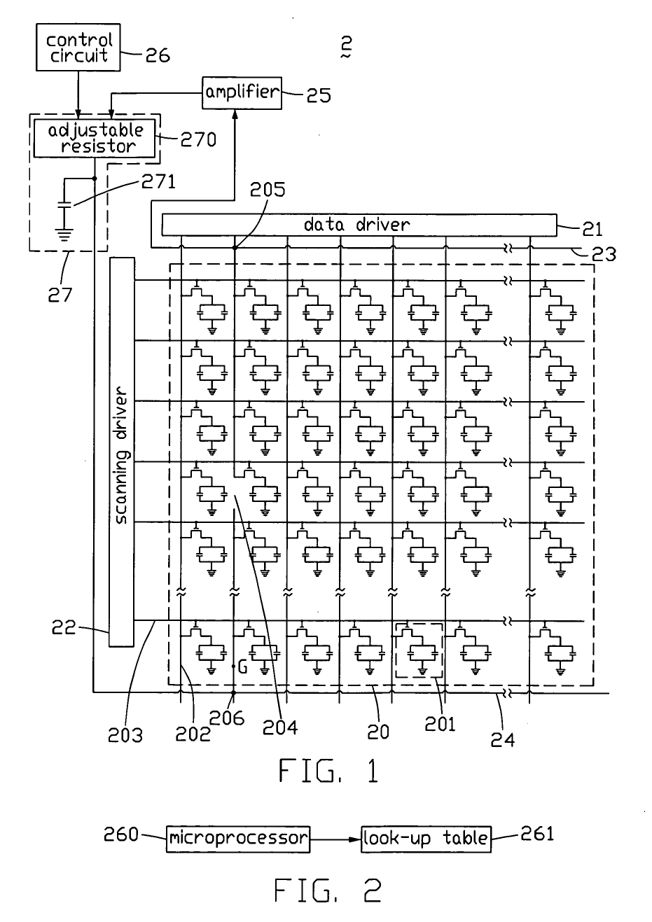

FIG. 1 is a circuit diagram of an embodiment of an LCD device 2 according to the disclosure. The LCD device 2 includes a display area 20, a data driver 21, a scanning driver 22, a first repair line 23, a second repair line 24, an amplifier 25, a control circuit 26, and a delay circuit 27. The display area 20 includes a plurality of pixel units 201, a plurality of scanning lines 203, and a plurality of data lines 202. The scanning driver 22 switches the pixel units 201 on or off via the scanning lines 203. The data driver 21 provides data signals to the pixel units 201 via the data lines 202.

The first repair line 23 intersects and is disposed on a first side of the data line 202. The second repair line 24 intersects and is disposed on a second side of the data line 202. The first side of the data line 202 is adjacent to the data driver 21, and the second side of the data line 202 is distant from the data driver 21. Further, the two repair lines 23, 24 are disposed beyond the display area 20 to avoid generation of capacitance with other metal lines.

When the data line 202 experiences a break point, the pixel units 201 below the break point cannot receive the data signals via the broken data line 202. An intersection of the broken data line 202 and the first repair line 23 is defined as a first crossing point 205. An intersection of the broken data line 202 and the second repair line 24 is defined as a second crossing point 206. In order to repair the broken data line 202, the broken data line 202 and the first repair line 23 may be shorted at the first crossing point 205 by a laser, and the broken data line 202 and the second repair line 24 may be shorted at the second crossing point 206 by the laser. As a result, data signals are sent from the data driver 21 to pixel units 201 above the break point via the broken data line 202, and to the remaining pixel units 201 below the break point via the first repair line 23, the amplifier 25, the delay circuit 27, the second repair line 24 and the broken data line 202.

The delay circuit 27 includes an adjustable resistor 270 and a capacitor 271. The adjustable resistor 270 is connected to the second repair line 24, and is grounded via the capacitor 271. The control circuit 26 adjusts a resistance of the adjustable resistor 270 according to a position of each pixel unit 201 corresponding to the broken data line 202. Thereby, a delay time of the delay circuit 27 can be adjusted. A plurality of points on the data line 202 is defined. A longitudinal coordinate of each point corresponds to a position of each pixel unit 201.

Referring to FIG. 2, a circuit block diagram of the control circuit 26, the control circuit 26 includes a microprocessor 260 and a look-up table 261. The look-up table 261 stores longitudinal coordinates of points on the data line 202 and compensation resistances corresponding to the points. A calculating method for the compensation resistances follows.

A parameter N denotes a distance between the first crossing point 205 and the second crossing point 206. A parameter R1 denotes a resistance of one data line 202. A parameter R2 denotes a resistance from the first crossing point 205 to the amplifier 25 of the first repair line 23. A parameter R3 denotes a resistance from the delay circuit 27 to the second crossing point 206 of the second repair line 24. The first crossing point 205 of the data line 202 is regarded as a coordinate origin. If a longitudinal coordinate of the break point is a parameter Y and a longitudinal coordinate of an arbitrary point G of the data line is a parameter Y1, a compensation resistance for the arbitrary point G is denoted as a parameter VR.

Y1 exceeding Y and Y exceeding N/2 or Y1 exceeding N/2 and Y being less than N/2 can be expressed by the formula:

(Y1/N)×R1=R2+VR+R3+(N−Y1)×R1/N (1)

Because the first repair line 23 and the second repair line 24 are comparatively wide, R2 and R3 can be discounted. As a result, formula (1) can be further expressed as:

(Y1/N)×R1=VR+N−Y1)×R1/N (2)

According to formula (2), the compensation resistance VR can be expressed as:

VR=(Y1−N/2)×R1/(N/2) (3)

A method for adjusting the resistance of the adjustable resistor 270 is described as follows. Longitudinal coordinate Y of the break point and the longitudinal coordinate Y1 of points G corresponding to pixel units 202 are determined. When Y1 exceeds Y and Y exceeds N/2 or Y1 exceeds N/2 and Y is less than N/2, the microprocessor 260 locates a corresponding compensation resistance VR in look-up table 261 according to a longitudinal coordinate Y1 of each point G, and adjusts the resistance of the adjustable resistor 270 to VR. When Y1 is less than Y or Y1 is less than N/2, the microprocessor 260 adjusts the resistance of the adjustable resistor 270 to zero.

LCD device 2 further includes the delay circuit 27 and the control circuit 26. Under control of the control circuit 26, the delay circuit 27 delays the data signal transmitted through the first repair line 23 and the second repair line 24 according to the position of each pixel unit 201 of the broken data line 202. Thus, the delay of the data signal of the lower part of the broken data line 202 nearly equals the delay of the data signal of corresponding positions of the other data lines 202. Brightness of pixel units 201 below the break point equals those of other pixel units 201 in the same rows. Display performance of the LCD device is thus maintained.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the disclosure to the full extent indicated by the broad general meaning of the terms in which the appended claims are expressed.

What is claimed is:

1. A liquid crystal display (LCD) device comprising:
a plurality of data lines,
a plurality of pixel units,
a first repair line intersecting the data line and disposed on a first side thereof,
a second repair line intersecting the data line and disposed on a second side thereof,
a delay circuit connected between the first repair line and the second repair line, and
a control circuit to control a delay time of the delay circuit according to a position of each pixel unit corresponding to a broken data line.

2. The LCD device of claim 1, wherein the delay circuit comprises an adjustable resistor, the control circuit controlling a resistance of the adjustable resistor according to the position of each pixel unit corresponding to the broken data line.

3. The LCD device of claim 2, wherein the adjustable resistor is connected between the first repair line and the second repair line.

4. The LCD device of claim 3, wherein the delay circuit further comprises a capacitor, to ground the adjustable resistor.

5. The LCD device of claim 2, wherein the control circuit comprises a look-up table storing longitudinal coordinates of points on one data line and compensation resistances corresponding to the point.

6. The LCD device of claim 5, wherein the control circuit further comprises a microprocessor to locate a corresponding compensation resistance in the look-up table according to a longitudinal coordinate of each point and adjust a resistance of the adjustable resistor to the corresponding compensation resistance.

7. The LCD device of claim 6, wherein a longitudinal coordinate of each point corresponds to a position of each pixel unit.

8. The LCD device of claim 7, wherein a parameter N denotes a distance between the first side of the data line and the second side of the data line, a parameter R1 denotes a resistance of one data line, a parameter Y denotes a longitudinal coordinate of the break point, a parameter Y1 denotes a longitudinal coordinate of an arbitrary point of the broken data line and a parameter VR denotes a compensation resistance for the arbitrary point, wherein when Y1 exceeds Y and Y exceeds N/2 or Y1 exceeds N/2 and Y is less than N/2, VR is (Y1−N/2)×R1/(N/2).

9. The LCD device of claim 8, wherein when Y1 is less than Y, VR is zero.

10. The LCD device of claim 9, wherein when Y1 is less than N/2, VR is zero.

11. The LCD device of claim 1, further comprising an amplifier connected between the delay circuit and the first repair line.

12. The LCD device of claim 1, further comprising a data driver supplying data signals to the pixel units via the data lines.

13. The LCD device of claim 12, wherein when one data line generates a break point, the first and the second repair lines and the broken data line are shorted respectively by laser.

14. A liquid crystal display (LCD) device, comprising:
a plurality of data lines,
a plurality of pixel units,
a first repair line intersecting the data line and disposed on a first side thereof
a second repair line intersecting the data line and disposed on a second side thereof,
a delay circuit,
a data driver to provide data signals, and
a control circuit,
wherein, when the data line generates a break point, data signals are sent to pixel units below the break point via the first repair line, the delay circuit, the second repair line and the broken data line, and the control circuit to control a delay time of the delay circuit according to a position of each pixel unit corresponding to a broken data line.

15. The LCD device of claim 14, wherein the delay circuit comprises an adjustable resistor, the control circuit controlling a resistance of the adjustable resistor according to the position of each pixel unit corresponding to the broken data line.

16. The LCD device of claim 15, wherein the adjustable resistor is connected between the first repair line and the second repair line.

17. The LCD device of claim 16, wherein the delay circuit further comprises a capacitor, to ground the adjustable resistor.
